(19) United States
(12) Patent Application Publication
(10) Pub. No.: US 2017/0328370 A1
(43) Pub. Date: Nov. 16, 2017

(54) Cordless Fan

(71) Applicant: Sara Bloom, Houston, TX (US)

(72) Inventor: Sara Bloom, Houston, TX (US)

(21) Appl. No.: 15/154,084

(22) Filed: May 13, 2016

(51) Int. Cl. F04D 25/08; F21V 23/04; F21S 8/00; F04D 29/70; F04D 29/52; F04D 29/32; F04D 25/06; F21V 33/00; F04D 19/00

(52) U.S. Cl. CPC F04D 25/08; F21V 33/0096; F21V 23/04; F21S 8/035; F04D 19/002; F04D 29/522; F04D 29/325; F04D 25/06; F04D 29/703

(57) ABSTRACT

A cordless wall fan having a front and rear housing, and safety grills, that plugs directly into a wall socket, and configured to safely provide air movement in the home and white noise near sleeping children, without taking up space on horizontal surfaces and without using potentially dangerous power cords.

### CROSS-REFERENCE TO RELATED APPLICATIONS

This application claims the benefit of U.S. Provisional Patent Application 62/198,766, filed Jul. 30, 2015. The contents of this application are hereby incorporated by reference.

### FIELD OF INVENTION

The present invention encompasses a device that circulates air in a bedroom, kitchen, office or any other area indoors, and more specifically but not by way of limitation, relates to a room fan that has an electrical plug built into the rear housing of the device. This enables the fan to plug directly into an electrical socket and sit flush against a wall rather than the floor or a tabletop surface.

### BRIEF SUMMARY OF THE INVENTION

Conventional room fans have been shown to have limitations, particularly when it comes to the cord and fan placement. Cord accidents are one of the most reported household dangers, especially involving children. Not only are cords a tripping hazard, but dangers of electrical shock and fire exist if a cord is frayed or nicked. A tabletop surface is not always available to rest a fan based on the outlet arrangement in a room. This leaves the fan sitting on the floor, which is also aesthetically unpleasing and potentially dangerous if the openings of the fan face are wide.

A further and more specific issue relates to the widespread use of fans in infant nurseries and children's rooms. A study in the Archives of Pediatric Adolescent Medicine found that increased air circulation in a nursery from the use of a fan could reduce an infant's risk of Sudden Infant Death Syndrome by up to 72%. Arch Pediatr Adolesc Med. 2008; 162(10):963-968. As a result, safe sleep advocate groups recommend putting a fan in all rooms where infants sleep. The issue here again lies in the cord as well as the box-like nature of fans. Cords in the nursery can pose a strangulation hazard and electrical shock hazard from potential chewing of the cord. Further, when a fan is on a tabletop surface, a tipping hazard exits as a toddler or child needs to simply tug on the cord for the box-like fan to tip and fall on top of the child.

Conventional room fans also lack portability. When traveling with an infant, it is likely a caregiver will want to bring the nursery fan. Cords can get tangled and damaged when trying to pack them in a bag or a suitcase.

Accordingly, there is a need for a room fan that eliminates the electrical cord and affixes directly to the wall socket via an electrical plug built into the back face of the fan (rear housing). This not only keeps the fan off the floor, but allows the fan to be placed in areas of the room that would otherwise not be available for air circulation. For instance, one could plug the wall fan into an electrical socket on the wall where the crib sits for maximum air circulation around an infant.

An additional improvement in functionality includes rear housing bracing elements which allow the cordless fan to plug directly into an electrical socket and sit flush with the wall while allowing sufficient air flow to reach behind the fan. This feature also reduces the space needed to operate the device.

It is an object of this invention to provide a cordless wall fan. It is a further object of this invention to provide a cordless wall fan that has the electrical plug built-in to the rear housing of the fan. It is a further object of this invention to provide a cordless wall fan case (i.e. housing) that affixes directly into an electrical socket. It is a further object of this invention to provide a cordless wall fan that can rest flush against a wall, without the need for an additional level or horizontal space to rest upon. It is a further object of this invention to provide a cordless wall fan with grills for air escape that are small enough to prevent toddler fingers from entering.

### COMPONENT NUMBERING

10. Fan Device
12. Primary Plug Base
14. Secondary Plug Base
16. Plug Prongs
18. Rear Fan Housing
20. Rear Housing Bracing Element (feet)
22. Rear Housing Grill
24. Motor
26. Fan On/Off Switch Mechanism
28. Lighting On/Off Switch Mechanism
30. Front Grill
32. Rear Mounting Element
34. Rear Grill Housing Connector
36. Nightlight Mechanism (with bulbs)

### BRIEF DESCRIPTION OF THE DRAWINGS

FIG. 1 is a rear side view of the cordless wall fan, illustrating the rear housing bracing elements, the primary and secondary plug bases, the plug prongs, and the rear housing grill.

FIG. 2 is a bottom rear view of the cordless wall fan illustrating the rear housing bracing elements, the primary and secondary plug bases, the plug prongs, the fan on/off switch mechanism, the lighting on/off switch mechanism, and the rear housing grill.

FIG. 3 is a front view of an embodiment of the device illustrating an embodiment of the front grill.

FIG. 4 is a rear view of the device shown without the rear housing, illustrating the rear mounting element and rear grill housing connectors.

FIG. 5 is a rear perspective view of the device shown without the rear housing illustrating the primary plug base, the plug prongs, the fan on/off switch mechanism, the lighting on/off switch mechanism, and the nightlight mechanism, and the fan motor.

FIG. 6 is a rear perspective view of the device shown with the rear housing.

FIG. 7 is a rear view of the device shown without the rear housing, illustrating the primary plug base, the plug prongs, the fan on/off switch mechanism, the lighting on/off switch mechanism, and the nightlight mechanism.

FIG. 8 is a rear view of the device shown without the rear housing, illustrating the rear mounting element, the rear grill housing connectors, and the nightlight mechanism.

FIG. 9 is a rear view of the device shown without the rear housing, illustrating the primary plug base, the plug prongs, the fan on/off switch mechanism, the lighting on/off switch mechanism, and the nightlight mechanism.

FIG. 10 is a rear view the device shown with the rear housing, illustrating the primary and secondary plug bases, the plug prongs, and the rear housing grill.

FIG. 11 is a rear view of the device shown without the rear housing, illustrating the primary and secondary plug bases, the plug prongs, the fan on/off switch mechanism, the lighting on/off switch mechanism, the rear grill housing connectors, and the nightlight mechanism.

FIG. 12 is a front perspective view of an embodiment of the device illustrating an embodiment of the front grill.

FIG. 13 is a front view of an embodiment of the device illustrating an embodiment of the front grill, the fan on/off switch mechanism, and the lighting on/off switch mechanism.

FIG. 14 is a bottom rear view of the cordless wall fan illustrating the rear housing bracing elements, the primary and secondary plug bases, the plug prongs, the fan on/off switch mechanism, the lighting on/off switch mechanism, and the rear housing grill.

### DETAILED DESCRIPTION OF THE INVENTION

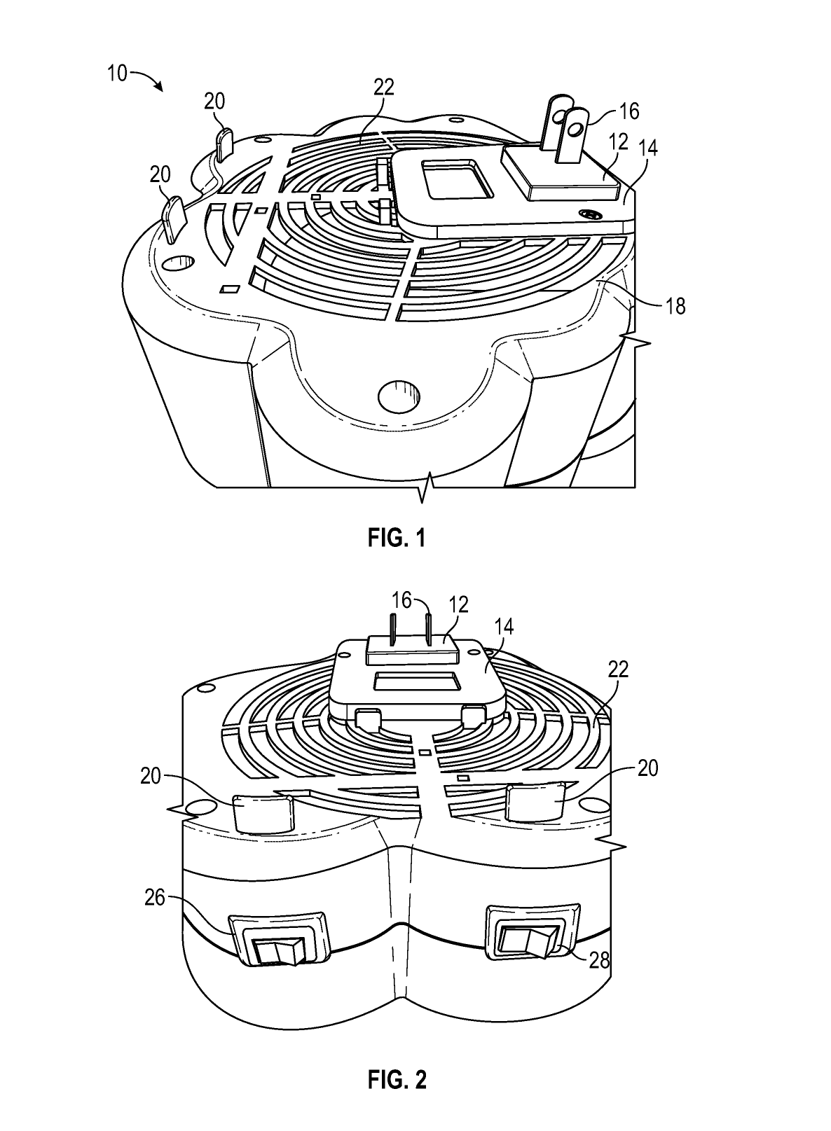

FIGS. 1 and 2 show a rear side and bottom rear view of the cordless wall fan 10, illustrating the rear housing bracing elements 20, the primary plug base 12, the secondary plug base 14, the plug prongs 16, and the rear housing grill 22. The plug prongs 16 are shown here in a two prong (ungrounded) configuration. However, the plug prongs could also comprise a three prong (grounded) configuration.

In order for the device 10 to sit flush against a wall, the plug prongs 16 are separated from the rear grill 22. In the illustrations, the separation is accomplished via one or more plug bases. Specifically, the plugs are directly attached to a primary plug base 12. This primary plug base may be sufficient to separate the plug prongs from the rear grill 22 and the rear fan housing 18. However, the preferred embodiment comprises a secondary plug base 14 to provide additional separation from the rear fan housing 18. The separation is needed to allow for air induction behind the fan and to allow air circulation behind. Ideally, the plug prongs 16 are located near the top of the rear housing grill 22. The rear housing grill 22 is also the air intake opening, and the front grill 30 is the air exhaust opening. In such a configuration, if the device is plugged into the bottom outlet of a two outlet socket, the top outlet would remain free for an additional device. An alternative configuration would locate the plug prongs 16 on the bottom of the rear housing grill 22 which would allow the fan to be plugged into the top of a two outlet socket, allowing for an additional device to be plugged into the bottom socket.

Importantly, rear housing bracing elements 20 are located on the opposite side from the location of the plug prongs 16. For example, if the plug prongs 16 are located on the top of the rear housing grill 22, the rear housing bracing element(s) 20 should be located on the bottom of the rear housing grill 22. The purpose for this configuration is to allow the fan to sit flush with the wall when plugged in.

The ideal configuration is wherein the length of the rear housing bracing element 20 (i.e. the length of the protrusion(s) of the bracing element 20 from the rear housing 18) will equal the distance between the top most surface of the primary plug base 12 (located at the intersection of the plug prongs 16 and the primary plug base 12). Such a configuration will optimize the stability of the fan 10 against the wall, and allow for sufficient air flow.

The fan on/off switch 26 is shown as a toggle type switch, but can be configured in a variety of ways, including a button, or a variable strength setting. This would allow the fan to be used at variable settings from high to low. Included, but not shown, is a fan timer which allows the user to turn the fan on for a limited period of time, then turn off automatically. Also included but not shown is a variable lighting mechanism which would allow the user to adjust the strength of the lighting from low to high, as well as a timing mechanism, which would allow the user to activate the light for a limited period of time and then turn off automatically.

An alternative configuration would include the primary plug base 12 and plug prongs 16 to be located on the side of the housing (as opposed to the rear of the housing 18 shown in the drawings). This would allow the fan to be oriented such that the fan could move air along the side of the wall as opposed to away from the wall. This configuration may be preferred in some circumstances. In such a configuration, the housing bracing elements 20 would need to be located on the side of the housing as well to balance the fan to keep it stable during use.

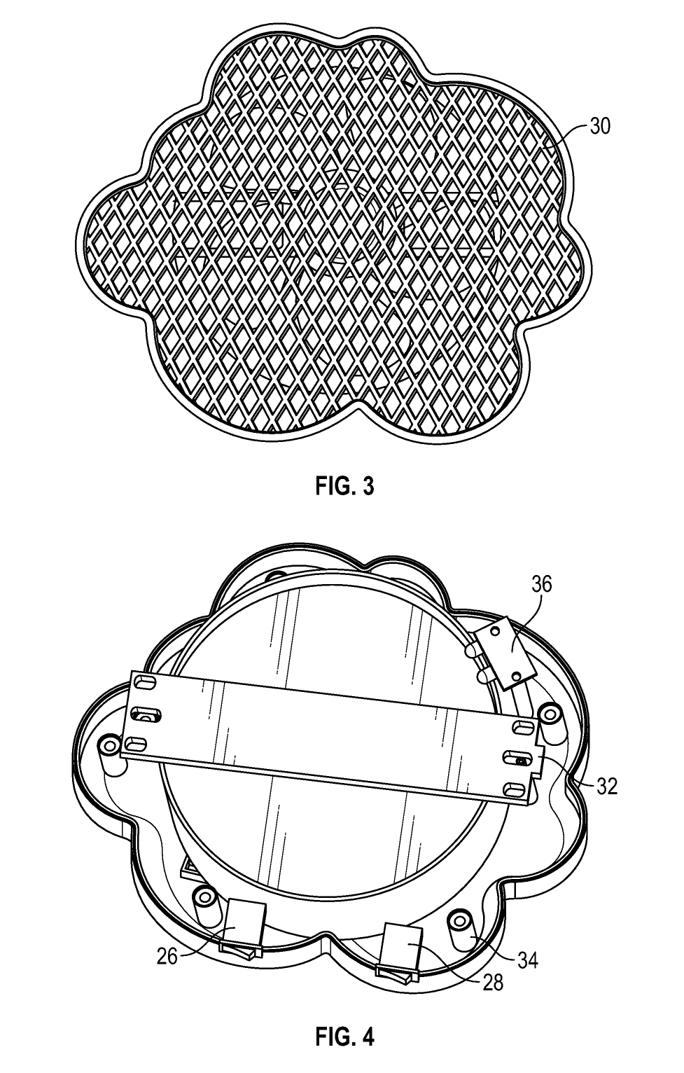

FIG. 3 and FIG. 12 are front views of an embodiment of the device illustrating an embodiment of the front grill 30. The front grill 30 can utilize a variety of designs, however it is important that the open portions on the grill should be small in size such that a child's fingers should be unable to fit through the openings and expose them to injury via the moving fan blades (not shown) during use. This is true for the rear grill as well. The multi-curved outline of the front grill is merely an example of the shape that the front grill can use, however a variety of the shapes can be used and shouldn't have a significant effect on the utilitarian nature of the invention. The shapes could include, but are not limited to, square, circle, and/or any polygon shape consistent with the required internal components or other required claim elements.

FIG. 4 is a rear view of the device shown without the rear housing 18, illustrating the rear mounting element 32 and rear grill housing connectors 34. The nightlight mechanism 36, shown here with the incorporated light bulbs, allows the user to turn on/off the lighting feature if desired by using the on/off switch mechanism 28. The nightlight mechanism 36 can also include an adjustable timer to provide light for a finite amount of time (e.g. 20 minutes). The Fan on/off switch mechanism 26 and the lighting on/off switch mechanism 28 may include a feature where these switches are always lit (if the device 10 is plugged in and powered), so as to allow the user to locate the switches in the dark. Alternatively, the switches 26, 28 may include phosphorescent “glow in the dark” materials so they can be located in an unpowered condition.

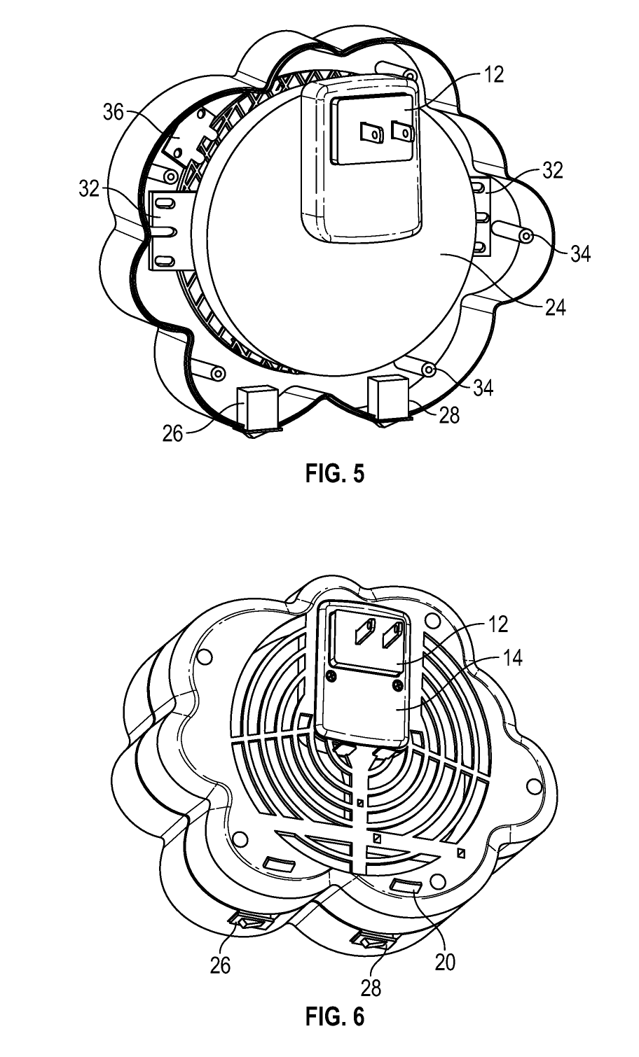

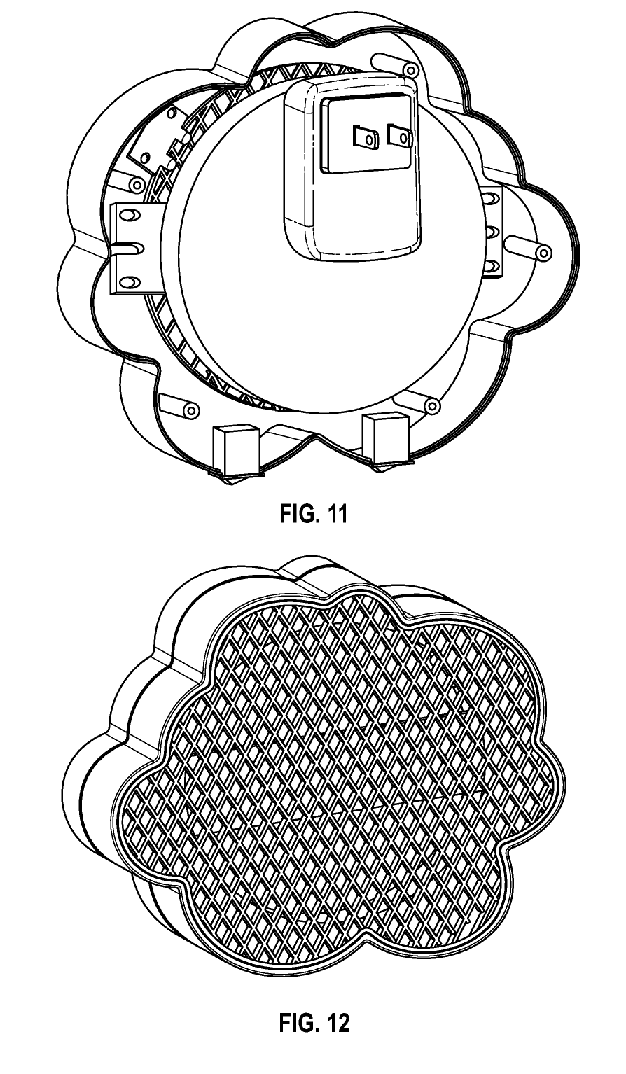

FIG. 5 and FIG. 11 are rear perspective views of the device shown without the rear housing 18, showing the primary plug base 12, the plug prongs 16, the fan on/off switch mechanism 26, the lighting on/off switch 28, the associated nightlight mechanism 36, and the fan motor 24. Again, the rear grill housing connectors 34 are used to connect the rear housing 18.

FIG. 6, FIG. 10 and FIG. 14 are rear perspective views of the device shown with the rear housing 18. The secondary plug base 14 adds depth and space between the rear housing grill 22 and the plug prongs 16. This space is needed to allow air to enter from the sides of the device and into the rear grill housing 22. Without such a space, the rear housing would lay flush against the wall and not provide proper air flow through the fan. Again, the ideal configuration is wherein the length of the rear housing bracing element 20 (i.e. the length of the protrusion(s) of the bracing element 20 from the rear housing 18) will equal the distance between the top most surface of the primary plug base 12 (located at the intersection of the plug prongs 16 and the primary plug base 12). Such a configuration will optimize the stability of the fan 10 against the wall, and allow for sufficient air flow into the rear grill housing 22.

An alternative configuration would omit the secondary plug base 14, and instead incorporate a primary plug base 12 that has sufficient thickness to provide enough depth between the plug prongs 16 and the wall to allow proper air flow from the sides of the device and into the rear grill housing 22. Optimally, the bracing elements 20 will be of sufficient length to balance the device and keep it in a vertical alignment by bracing the bottom of the device against the wall.

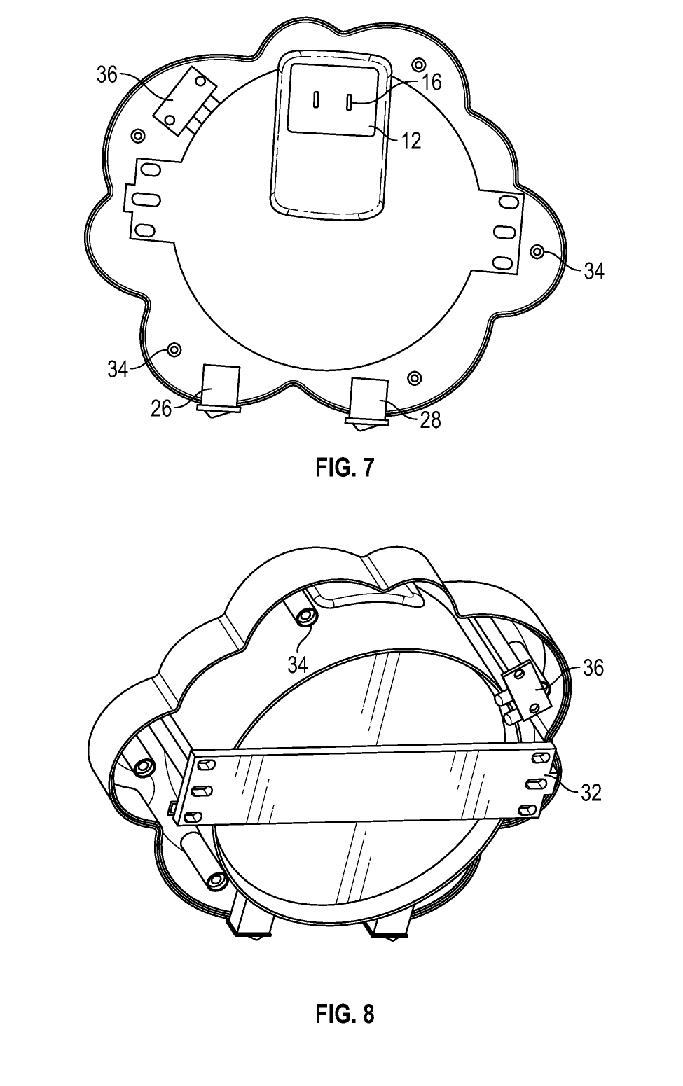

FIG. 7 is a rear view the device shown without the rear housing 18 or rear housing grill 22, illustrating the primary plug base 12, the plug prongs 16, the fan on/off switch mechanism 26, the lighting on/off switch 28, the nightlight mechanism 36, and the rear grill housing connectors 34.

FIG. 8 is a rear perspective view the device shown without the rear housing, illustrating the rear mounting element, the rear grill housing connectors 34, and the nightlight mechanism 36 which include the attached nightlight bulbs. The lighting bulbs can be incandescent, CFL, or LED, and may be “white” light, and/or of any color including red, yellow, orange, blue, green, indigo, or violet.

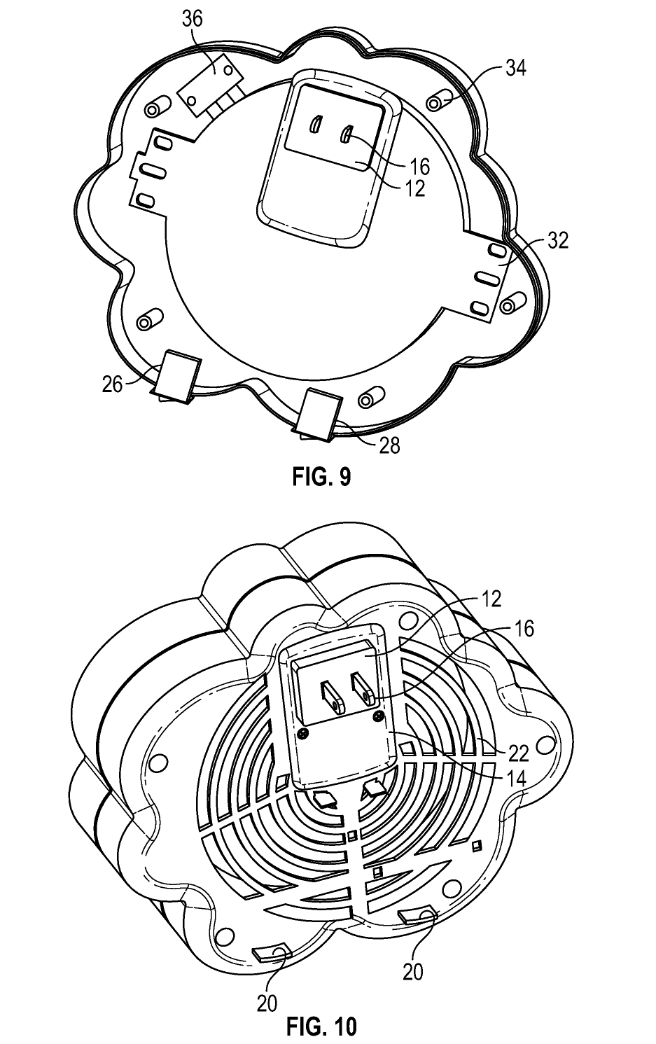

FIG. 9 is a rear view the device shown without the rear housing 18 or rear housing grill 22, illustrating the primary plug base 12, the plug prongs 16, the fan on/off switch mechanism 26, the lighting on/off switch 28, the nightlight mechanism 36, and the rear grill housing connectors 34.

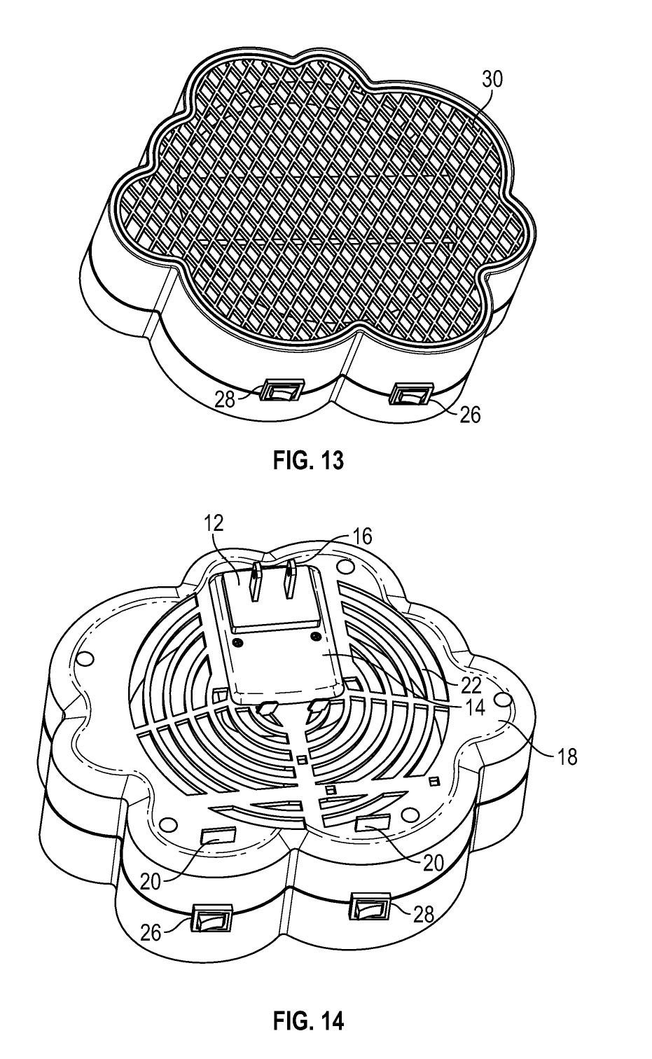

FIG. 13 is a front perspective view of an embodiment of the device illustrating an embodiment of the front grill 30, the fan on/off switch mechanism 26, and the lighting on/off switch 28.

FIG. 14 is a bottom rear view of the cordless wall fan illustrating the rear housing bracing elements, the primary and secondary plug bases, the plug prongs, the fan on/off switch mechanism, the lighting on/off switch mechanism, and the rear housing grill.

1. A cordless wall fan, comprising:
a. A fan housing, comprising:
i. A power on/off switch;
ii. a rear housing comprising:
1. a rear grill;
2. a secondary plug base attached to, and protruding from, the rear housing, comprising:
a. electrical plug prongs protruding from the secondary plug base;
3. one or more rear housing bracing elements, wherein the rear housing bracing elements:
a. are attached to the rear housing;
b. protrude from the rear housing;
4. wherein the secondary plug base and the rear housing bracing element(s) protrude from the rear housing approximately the same distance;
iii. a front housing, comprising a front grill;
b. fan blades capable of rotation about an axis; and
c. an electric motor capable of rotating the fan blades.

2. The cordless wall fan of claim 1, further comprising a primary plug base, wherein the primary plug base:
a. is attached to, and protrudes from, the secondary plug base;
b. wherein the electrical plug prongs are attached to, and protrude from, the primary plug base; and
c. protrudes from the rear housing a distance equal to the length of the rear housing bracing elements.

3. The cordless wall fan of claim 1, further comprising:
a. A lighting mechanism, including:
i. A lighting on/off switch;
ii. One or more lighting elements.

4. The cordless wall fan of claim 3, further comprising a nightlight timer capable of turning off the lighting mechanism automatically after a specified period of time.

5. A cordless wall fan, comprising:
a. A fan housing, comprising:
i. A power on/off switch;
ii. a rear housing comprising:
1. a rear grill;
iii. a side housing comprising:
1. a secondary plug base attached to, and protruding from, the side housing, comprising:
a. electrical plug prongs protruding from, the secondary plug base;
2. one or more side housing bracing elements, wherein the side housing bracing elements:
a. are attached to the side housing;
b. protrude from the side housing;
3. wherein the secondary plug base and the side housing bracing element(s) protrude from the side housing approximately the same distance;
iv. a front housing, comprising a front grill;
b. fan blades capable of rotation about an axis; and
c. an electric motor capable of rotating the fan blades.

6. The cordless wall fan of claim 5, further comprising:
a. A lighting mechanism, including:
i. A lighting on/off switch;
ii. One or more lighting elements.

7. The cordless wall fan of claim 5, further comprising a primary plug base, wherein the primary plug base:
a. is attached to, and protrudes from, the secondary plug base;
b. wherein the electrical plug prongs are attached to, and protrude from, the primary plug base; and
c. protrudes from the side housing a distance equal to the length of the side housing bracing elements.
